(19) United States
(12) Patent Application Publication
(10) Pub. No.: US 2017/0101262 A1
(43) Pub. Date: Apr. 13, 2017

(54) Methods and apparatus for securing a liner

(71) Applicant: Stephen Craig Boorman, Nassau (BS)

(72) Inventor: Stephen Craig Boorman, Nassau (BS)

(21) Appl. No.: 15/288,136

(22) Filed: Oct. 7, 2016

Related U.S. Application Data
(60) Provisional application No. 62/238,505, filed on Oct. 7, 2015.

(51) Int. Cl. B65F 1/06; B65F 1/16

(52) U.S. Cl. CPC B65F 1/06; B65F 1/16; B65F 2250/12

(57) ABSTRACT

The present invention comprises apparatus and methods for securing a liner to an article, for example, a container. According to one embodiment, a liner stay apparatus is described, which may be selectively used in connection with a container or the like to secure a removable liner. Methods of using the apparatus are also described.

### CROSS-REFERENCE TO RELATED APPLICATIONS

This application claims the benefit of U.S. Provisional Patent Application No. 62/238,505, filed Oct. 7, 2015, the entire disclosure of which is incorporated herein by reference.

### FIELD OF THE INVENTION

The present invention relates to apparatus and methods for securing a liner, such as for a container, and in particular to liner stays that secure a removable liner and methods for use thereof.

### BACKGROUND OF THE PRESENT INVENTION

Containers and receptacles that are intended for use with removable liners presently lack an effective way to keep the liner in proper position within the container. Not only does a removable liner that is kept in proper position serve the purpose of collecting and housing the contents placed in the container, but also preserving the integrity of the container by keeping it separated from the contents and thereby making the container easy to clean after each use. Prior attempts to keep a removable liner in place have been made, but have failed to address problems identified herein.

For example, prior devices supplied to resolve this problem have been ineffective at maintaining the position of the liner relative to the container, and include devices such as bungee cords, cinch cords or rubber bands to hold the liner in place, or clip-on items that pinch the top edge of the liner. However, these prior devices are fundamentally flawed because they are incapable of maintaining a strong bond with the liner material, and often break or wear out prior to the life of the reusable container. Other prior designs include systems of holding a removable liner in place with wire placed around or atop of the container's rim, but such designs are flawed as they have many parts, such as springs or clasps that easily fail, are difficult to install and/or remove, and are particularly difficult to clean and/or maintain.

Overall, the prior designs and inventions for securing a removable liner in place have been lacking with respect to ease of use, effectiveness, and ease of incorporation into the design of a container. The present invention is readily distinguishable from these prior devices because it solves all of those problems and creates a unique, simple solution for consumers.

### BRIEF SUMMARY OF EMBODIMENTS OF THE INVENTION

The present invention relates to a mechanism for holding a removable liner in place inside a container or receptacle. For illustrative purposes but not intended to limit the present invention, an example of an application of the present invention is a garbage container that is used with a removable liner (trash bag), which can be equipped with the present invention as a liner securing mechanism. The present invention applies to containers of any size and shape, with or without a lid, in which removable liners may be placed.

It is one aspect of the present invention to provide a stay for a removable container liner, comprising at least one device, the at least one device configured to be disposed near a top of, and substantially flush with an exterior vertical surface of, a container, wherein the device comprises an exterior surface having an insertion location, the insertion location comprising a plurality of slits in the exterior surface, the slits disposed in a substantially rotationally symmetric insertion pattern and configured to receive a portion of the removable container liner, wherein a material of the at least one device is selected to permit a user to press the portion of the removable container liner into the insertion location and to substantially retain an original shape of the insertion pattern thereafter.

In certain embodiments, the liner stay may be an integral component of the container.

In other embodiments, the at least one device may further comprise an interior surface comprising an adhesive, the adhesive configured to adhere the at least one device to the exterior vertical surface of the container.

In other embodiments, the material may be a rubber.

In other embodiments, the slits may radiate outwardly from a central point. The slits may be, by way of non-limiting example, four in number and separated by about 90°, or six in number and separated by about 60°, or eight in number and separated by about 45°.

It is another aspect of the invention to provide a system for securing a removable container liner, comprising a container and at least one device, the at least one device disposed near a top of, and substantially flush with an exterior vertical surface of, the container, wherein the device comprises an exterior surface having an insertion location, the insertion location comprising a plurality of slits in the exterior surface, the slits disposed in a substantially rotationally symmetric insertion pattern and configured to receive a portion of the removable container liner, wherein a material of the at least one device is selected to permit a user to press the portion of the removable container liner into the insertion location and to substantially retain an original shape of the insertion pattern thereafter.

In certain embodiments, the container may be a garbage container and the removable container liner may be a trash bag.

In other embodiments, the container may further comprise a lid.

In other embodiments, the at least one device may comprise at least two devices, and the at least two devices may be positioned at substantially equal intervals about a circumference of the container.

In other embodiments, the at least one device may be an integral component of the container.

In other embodiments, the material may be a rubber.

It is still another aspect of the present invention to provide a method for securing a removable container liner, comprising: a) providing a container and at least one device, the at least one device disposed near a top of, and substantially flush with an exterior vertical surface of, the container, wherein the device comprises an exterior surface having an insertion location, the insertion location comprising a plurality of slits in the exterior surface, the slits disposed in a substantially rotationally symmetric insertion pattern and configured to receive a portion of the removable container liner, wherein a material of the at least one device is selected to permit a user to press the portion of the removable container liner into the insertion location and to substantially retain an original shape of the insertion pattern thereafter; b) inserting the removable container liner substantially within the container; c) pulling an upper lip of the removable container liner over a rim of the container and downward such that a portion of the upper lip overlaps the insertion location; d) applying pressure to the portion of the upper lip to press the portion of the upper lip into the insertion location such that the portion of the upper lip is caught within the slits of the insertion location; and e) disengaging or releasing the pressure.

In certain embodiments, the container may be a garbage container and the removable container liner may be a trash bag.

In other embodiments, the method may further comprise f) placing a lid on the container.

In other embodiments, the at least one device may comprise at least two devices, and the at least two devices may be positioned at substantially equal intervals about a circumference of the container.

In other embodiments, the at least one device may be an integral component of the container.

One having skill in the art will appreciate that embodiments of the present invention may have various sizes. The sizes of the various elements may be sized based on various factors including, for example, the dimensions of a container associated therewith, the person operating or otherwise using the apparatus, the liner stay mounting location and/or orientation, the permanent nature of the liner stay, and the style and material of the liner to be secured.

Embodiments of the present disclosure present several advantages over the prior art including, for example, the speed and efficacy of use, the minimal number of parts, the disposability of the apparatus or elements thereof, the ability to use and reuse with different containers and/or liners, the application of the apparatus with minimal damage to the container and surrounding environment, the ability to provide one or more optimally placed liner stays in a removable manner, and providing a more stable and secure method of attaching a liner to the apparatus, among other advantages.

One having skill in the art will appreciate that embodiments of the present disclosure may be constructed of materials known to provide, or predictably manufactured to provide the various aspects of the present disclosure. These materials may include, for example, one or more fibers, plastic including but not limited to ABS, polyurethane and polyethylene, photo-polymers, resins, rubber, latex, synthetic rubber, synthetic materials, polymers, natural materials, chrome, brass, steel, stainless steel, titanium alloy, aluminum alloy and other metals or metal alloys.

The Brief Summary is neither intended nor should it be construed as being representative of the full extent and scope of the present invention. The disclosure is set forth in various levels of detail in the Brief Summary, as well as in the attached drawings and the Detailed Description, and no limitation as to the scope of the present invention is intended by either the inclusion or non-inclusion of elements, components, etc. in this Brief Summary. Additional aspects of the present disclosure will become more readily apparent from the Detailed Description, particularly when taken together with the drawings.

The above-described benefits, embodiments, and/or characterizations are not necessarily complete or exhaustive, and in particular, as to the patentable subject matter disclosed herein. Other benefits, embodiments, and/or characterizations of the present disclosure are possible utilizing, alone or in combination, as set forth above and/or described in the accompanying figures and/or in the description herein below. However, the claims set forth herein below define the invention.

### BRIEF DESCRIPTION OF THE DRAWINGS

The accompanying drawings, which are incorporated in and constitute a part of the specification, illustrate embodiments of the disclosure and together with the general description of the disclosure given above and the detailed description of the drawings given below, serve to explain the principles of the disclosures.

It should be understood that the drawings are not necessarily to scale. In certain instances, details that are not necessary for an understanding of the disclosure or that render other details difficult to perceive may have been omitted. It should be understood, of course, that the disclosure is not necessarily limited to the particular embodiments illustrated herein.

In the drawings:

FIGS. 1A through 1D are illustrations of various embodiments of devices according to the present invention;

FIG. 2 is an illustration of an application of devices according to the present invention;

FIG. 3 is a side view of a container equipped with devices according to the present invention;

FIG. 4 is an illustration of a removable liner secured with devices according to the present invention; and

FIG. 5 is an illustration of a method for securing a removable liner inside a container according to the present invention.

### DETAILED DESCRIPTION OF EMBODIMENTS OF THE INVENTION

As shown in the appended Figures and described in further detail herein, the present disclosure relates to novel apparatus and methods for securing a liner to, by way of example but not limitation, a container. More specifically, the present disclosure relates to a novel liner stay, which may be selectively used in connection with a compartment, receptacle, container or the like to secure a removable liner. Methods of using the apparatus of the present disclosure are also disclosed herein.

According to a preferred embodiment, the apparatus provides an effective solution for securing removable liners in place within containers and receptacles. To secure a removable liner in place within a container, the present invention comprises at least one device that is placed near the top of the reusable container into which the removable liner is inserted. The devices are mounted flush or nearly flush so as to not substantially change the size of the container and to conceal the appearance of the devices. The shape of the devices can be varied, as well as the insertion pattern within the devices, so long as there is an insertion point with which the devices may effectively secure a removable liner within the container.

The material composition of the devices is essential for the present invention to serve its intended purpose. Ideally the devices can be made of a soft material that prevents tearing or ripping of the removable liner upon installation, use, or removal. Additionally, the devices must have an insertion point for the removable liner and be rigid enough to grasp the liner, yet flexible enough to retain their original shape. The combination of flexibility and rigidity in the devices is what provides consumers with a simple, reusable mechanism for securing removable liners in the most effective position within containers.

In particular, the present invention is a solution for securing removable liners in containers comprising: (i) at least one device; (ii) placed near the top opening of a container; (iii) composed of soft, resilient materials (such as rubber, creating an effective, reusable combination of rigidity and flexibility); (iv) with an insertion location within the interior of the device; (v) into which a removable liner may be inserted, secured and removed; (vi) that can be applied to a container in order to secure a removable liner in proper place.

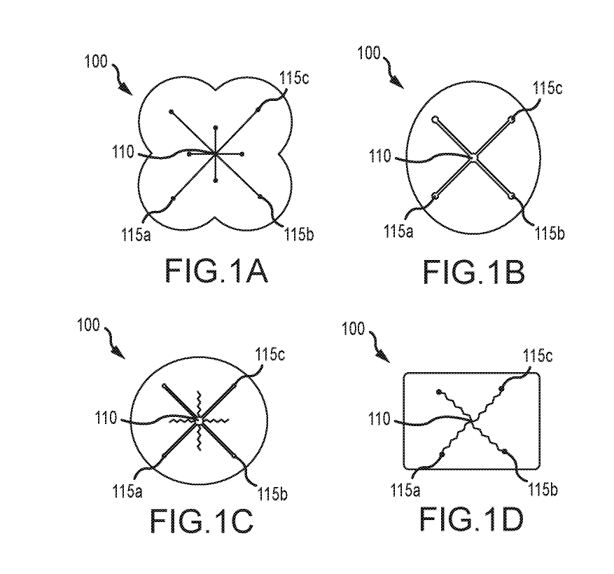

Referring now to FIGS. 1A through 1D, several embodiments of devices 100 are illustrated. Preferably, each device 100 comprises an insertion location 110, which in turn comprises a plurality of slits 115a,b,c. Slits 115 are disposed in a substantially rotationally symmetric insertion pattern and are configured to receive a portion of the removable container liner. The shape of the device 100 itself may vary; by way of non-limiting example, device 100 may be cloverleaf-shaped (as in FIG. 1A), circular or ovular (as in FIGS. 1B and 1C), or rectangular (as in FIG. 1D). Likewise, the number and shape of slits 115 may vary. The insertion location 110 may comprise four, six, eight, or any other number of slits 115, and the slits may vary in length (as in FIGS. 1A and 1C) and in shape (as in FIG. 1C).

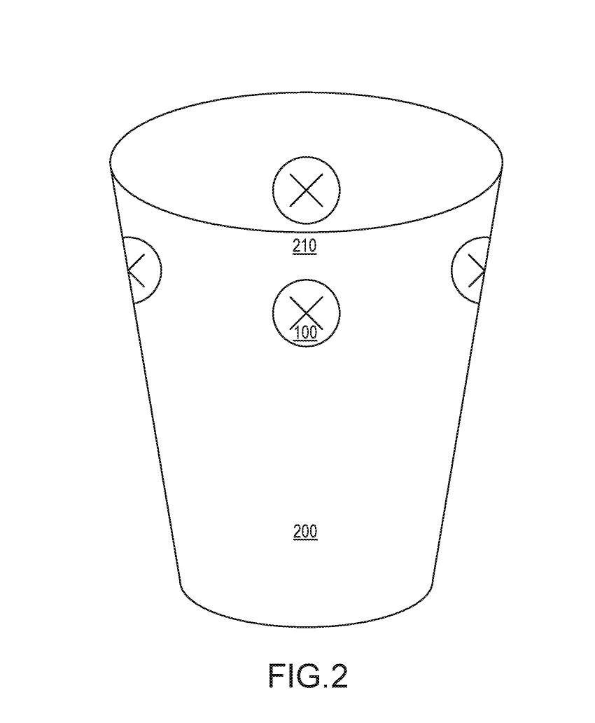

FIG. 2 illustrates a container 200 comprising devices 100 according to the present invention. Devices 100 are located near a top opening 210 of the container 200, and may be equidistantly spaced, or spaced however may be appropriate to effectively secure a removable liner within the container 200. Although the top opening 210 of the container 200 depicted in FIG. 2 has a round cross-section, the container 200 may be of any shape. The devices 100 may be an integral part of the container 200, or they may be separate pieces affixed to container 200, e.g. by an adhesive, but most preferably the devices 100 have a low profile and do not significantly alter the shape of the container 200.

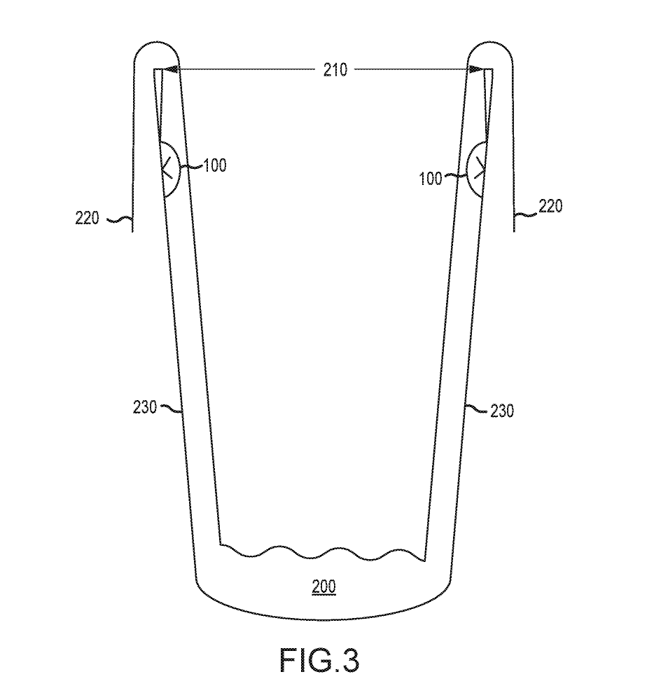

FIG. 3 illustrates how the devices 100 may be positioned in relation to the top opening 210 of the container 200. Note the position of the removable liner 220 and its overlapping of the top opening 210 of the container 200 to facilitate insertion of the liner 220 into the devices 100 on the exterior faces 230 of the container 200. In this embodiment, the devices 100 are built directly into and flush with exterior faces 230.

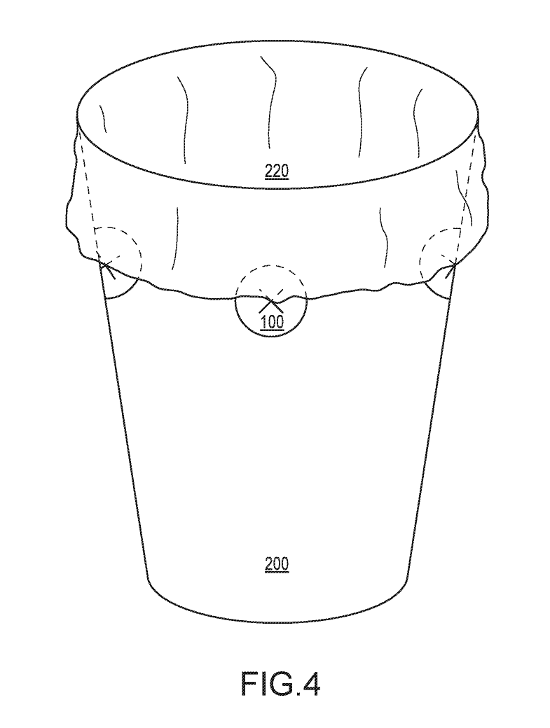

FIG. 4 depicts a system of the present invention, with removable liner 220 secured in position in container 200 by devices 100. The devices 100 provide an effective mechanism for holding the liner 220 in a desired position within the container 200.

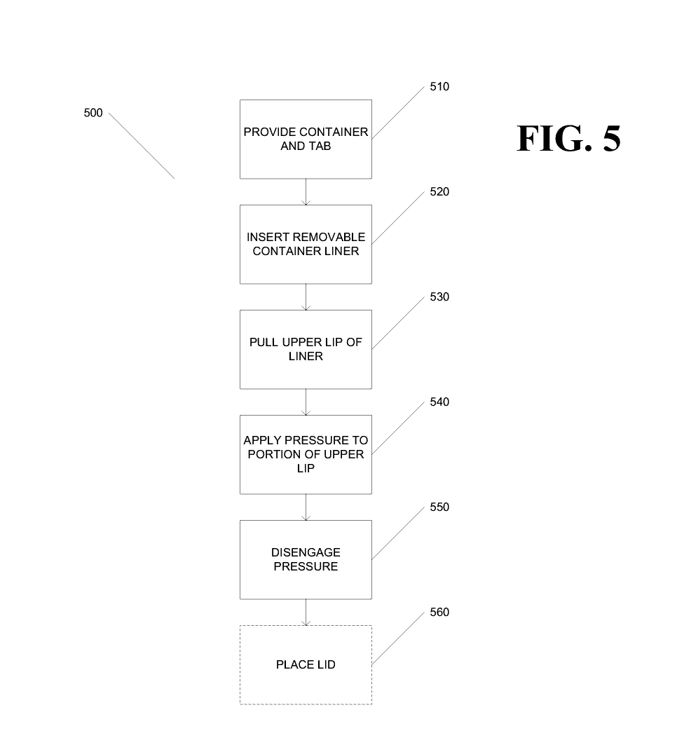

FIG. 5 is a flow chart depicting a method 500 for securing a removable liner in a container according to the present invention. In providing step 510, a container and at least one device are provided, the at least one device disposed near a top of, and substantially flush with an exterior vertical surface of, the container, wherein the device comprises an exterior surface having an insertion location, the insertion location comprising a plurality of slits in the exterior surface, the slits disposed in a substantially rotationally symmetric insertion pattern and configured to receive a portion of the removable container liner, wherein a material of the at least one device is selected to permit a user to press the portion of the removable container liner into the insertion location and to substantially retain an original shape of the insertion pattern thereafter. In inserting step 520, the removable container liner is inserted substantially within the container. In pulling step 530, an upper lip of the removable container liner is pulled over a rim of the container and downward such that a portion of the upper lip overlaps the insertion location. In applying step 540, pressure is applied to the portion of the upper lip to press the portion of the upper lip into the insertion location such that the portion of the upper lip is caught within the slits of the insertion location. In disengaging step 550, the pressure is disengaged. In optional placing step 560, a lid is placed on the container.

It is expressly understood that where the term “invention” has been used to describe various embodiments, the term should not be construed as limiting in any way, and should be understood to be synonymous with the term “disclosure.”

The foregoing disclosure has been presented for purposes of illustration and description. The foregoing is not intended to limit the disclosure to the form or forms disclosed herein. In the foregoing Detailed Description for example, various features of the disclosure are grouped together in one or more embodiments for the purpose of streamlining the disclosure. This method of disclosure is not to be interpreted as reflecting an intention that the claimed disclosure requires more features than are expressly recited in each claim. Rather, as the following claims reflect, inventive aspects lie in less than all features of a single foregoing disclosed embodiment. Thus, the following claims are hereby incorporated into this Detailed Description, with each claim standing on its own as a separate preferred embodiment of the disclosure.

The present inventions, in various embodiments, include components, methods, processes, systems and/or apparatuses substantially as depicted and described herein, including various embodiments, subcombinations, and subsets thereof. Those of skill in the art will understand how to make and use the present inventions after understanding the present disclosure. The present invention, in various embodiments, include providing apparatuses and processes in the absence of items not depicted and/or described herein or in various embodiments hereof, including in the absence of such items as may have been used in previous apparatuses or processes, e.g., for improving performance, achieving ease and/or reducing cost of implementation.

Moreover, though the present disclosure has included description of one or more embodiments and certain variations and modifications, other variations and modifications are within the scope of the disclosure, e.g., as may be within the skill and knowledge of those in the art, after understanding the present disclosure. It is intended to obtain rights which include alternative embodiments to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

1. A stay for a removable container liner, comprising at least one device, the at least one device configured to be disposed near a top of, and substantially flush with an exterior vertical surface of, a container,
wherein the device comprises an exterior surface having an insertion location, the insertion location comprising a plurality of slits in the exterior surface, the slits disposed in a substantially rotationally symmetric insertion pattern and configured to receive a portion of the removable container liner,
wherein a material of the at least one device is selected to permit a user to press the portion of the removable container liner into the insertion location and to substantially retain an original shape of the insertion pattern thereafter.

2. The stay of claim 1, wherein the stay is an integral component of the container.

3. The stay of claim 1, wherein the at least one device further comprises an interior surface comprising an adhesive, the adhesive configured to adhere the at least one device to the exterior vertical surface of the container.

4. The stay of claim 1, wherein the material is a rubber.

5. The stay of claim 1, wherein the slits radiate outwardly from a central point.

6. The stay of claim 5, wherein the slits are four in number, and wherein rotationally adjacent slits are separated by about 90°.

7. The stay of claim 5, wherein the slits are six in number, and wherein rotationally adjacent slits are separated by about 60°.

8. The stay of claim 5, wherein the slits are eight in number, and wherein rotationally adjacent slits are separated by about 45°.

9. A system for securing a removable container liner, comprising:
a container; and
at least one device, the at least one device disposed near a top of, and substantially flush with an exterior vertical surface of, the container,
wherein the device comprises an exterior surface having an insertion location, the insertion location comprising a plurality of slits in the exterior surface, the slits disposed in a substantially rotationally symmetric insertion pattern and configured to receive a portion of the removable container liner,
wherein a material of the at least one device is selected to permit a user to press the portion of the removable container liner into the insertion location and to substantially retain an original shape of the insertion pattern thereafter.

10. The system of claim 9, wherein the container is a garbage container and the removable container liner is a trash bag.

11. The system of claim 9, wherein the container further comprises a lid.

12. The system of claim 9, wherein the at least one device comprises at least two devices, the at least two devices positioned at substantially equal intervals about a circumference of the container.

13. The system of claim 9, wherein the at least one device is an integral component of the container.

14. The system of claim 9, wherein the material is a rubber.

15. A method for securing a removable container liner, comprising:
a) providing a container and at least one device, the at least one device disposed near a top of, and substantially flush with an exterior vertical surface of, the container,
wherein the device comprises an exterior surface having an insertion location, the insertion location comprising a plurality of slits in the exterior surface, the slits disposed in a substantially rotationally symmetric insertion pattern and configured to receive a portion of the removable container liner,
wherein a material of the at least one device is selected to permit a user to press the portion of the removable container liner into the insertion location and to substantially retain an original shape of the insertion pattern thereafter;
b) inserting the removable container liner substantially within the container;
c) pulling an upper lip of the removable container liner over a rim of the container and downward such that a portion of the upper lip overlaps the insertion location;
d) applying pressure to the portion of the upper lip to press the portion of the upper lip into the insertion location such that the portion of the upper lip is caught within the slits of the insertion location; and
e) disengaging the pressure.

16. The method of claim 15, wherein the container is a garbage container and the removable container liner is a trash bag.

17. The method of claim 15, further comprising:
f) placing a lid on the container.

18. The method of claim 15, wherein the at least one device comprises at least two devices, the at least two devices positioned at substantially equal intervals about a circumference of the container.

19. The method of claim 15, wherein the at least one device is an integral component of the container.

20. The method of claim 15, wherein the material is a rubber.
